(19) United States
(12) Patent Application Publication
(10) Pub. No.: US 2009/0027997 A1
(43) Pub. Date: Jan. 29, 2009

(54) Single-Use Container With Stirring Device

(75) Inventor: Hans Peter Meier, Wangen/Nuolen (CH)

Correspondence Address: PAULEY PETERSEN & ERICKSON, 2800 WEST HIGGINS ROAD, SUITE 365, HOFFMAN ESTATES, IL, 60195, US

(73) Assignee: ZETA AG BIOPROCESS SYSTEMS, Wangen SZ (CH)

(21) Appl. No.: 11/922,365

(22) PCT Filed: Oct. 2, 2006
(86) PCT No.: PCT/CH2006/000536

§ 371 Date: Sep. 4, 2008

(30) Foreign Application Priority Data
Oct. 3, 2005 (CH) 1588/05
Apr. 20, 2006 (CH) 649/06

(51) Int. Cl. B01F 7/00

(52) U.S. Cl. 366/281

(57) ABSTRACT

The invention is directed to a container fabricated out of plastic material for sterile liquids for the chemical, biotechnological, pharmaceutical and food industry, that includes a unit for mixing liquids whereby a flexible container wall is penetrated by a supporting shaft and is integrally connected with the container wall and an area of the inner space of the container supports at least one stirring device plate connectable with a drive outside of the inner space.

### FIELD OF THE INVENTION

The present invention relates to a single-use mixing container according to claim, comprising a mixing device for fluids, particularly for mixing sterile liquids for the chemical, biotechnological, pharmaceutical and food industry according to claim 1.

### BACKGROUND OF THE INVENTION

In the sterile production, particularly in the pharmaceutical and biotechnological industry, all surfaces which are coming into contact with the product or precursors thereof, must meet top requirements as no impurity access into the product is allowed via the surfaces. In order to reduce the costs for the parts of the installation per se, as for example, reactors, fermenters, mixing and transport containers and to avoid simultaneously the time-consuming and thus cost-intensive cleaning, the interest for sterile single-use containers has tremendously increased in recent years. Such single-use containers which are easily disposable after use, are known, for example, from the company Newport Bio Systems Inc., Anderson Calif., USA and are advertised with the slogan “Biobags for Biotech—a cleanroom in a bag”. Theses flexible single-use containers or biobags are made of class VI polyethylene with volumes between 0.5 and 2500 liters. Depending on the area of application (storage, transport, production), the construction of the flexible container wall differs, whereby mostly multilayer co-extruded foils (LLDPE, EVOH, LLDPE/EVA, NYLON (PVdC coated) are selected.

In order to realize all steps of production in single-use containers, containers of this type in which the mixing and/or stirring can be performed under sterile conditions must be provided too.

A bioprocess container is known from WO 2004/028674, wherein a flexible single-use container is arranged in a rigid receptacle. For the mixing or stirring of the fluid in the single-use container different devices, from a single-use magnetic stirrer to an agitator driven by a shaft of an external motor to inflatable hoses in the container wall which are moving the liquid in the container by alternating inflation and deflation destined to thereby obtain a mixing effect, are used. Particularly by the latter mixing method only a small quantity of energy can be brought into the solution such that it is probably only appropriate for a very gentle mixing, as it is also proposed by EP-A1-1'512'458 for cell cultures. The use of a magnetic stirrer involves two drawbacks. Either stirring can only be performed with a small quantity of energy again or powerful and thus expensive stirring devices or stirring units must be adopted. When using a stirring device which is connected via a shaft to an exterior drive, the driving shaft must be conducted through the container wall. In WO 2004/028674 it is merely suggested to use only a single-use aperture which is sealing the container wall against the shaft and thus prevents the leakage of the liquid to be mixed. In no way it is disclosed how theses goals are to be achieved. At present no easy methods for sealing a rotating shafts are known, which would be accepted in the sterile domain from the market and/or the approving regulating authorities.

This problem has also been identified in the U.S. Pat. No. 6,494,613 and it is proposed to bypass the sealing problem in that a hose penetrates the upper container wall protruding far into the interior of the container. The hose itself is flexible and sealed against the container's inner space. It can receive a rigid stirring unit which is brought in rotation by an external drive. This type of stirring device does in fact not require sealing of a rotatively supported shaft, but the stirring and mixing performance is very limited and totally unsatisfactory for many applications.

### SUMMARY OF THE INVENTION

It is an object of the present invention to provide a device which avoids the drawbacks mentioned above which is acceptable for the sterile domain and has a mixing and stirring performance meeting the maximal requirements. Furthermore it is an object of the invention to provide a method which does not feature the drawbacks mentioned above and can be employed even for the production of sterile solutions or mixtures.

These objects are achieved by a container with a device for stirring, mixing, emulsifying, and so forth of liquids, according to claim 1. The device for stirring, mixing, emulsifying, and so forth (only the terms stirring device and stirring are used hereinafter summarizingly) of liquids comprises at least one stirring unit arranged on a carrying axle. The carrying axle penetrates the container wall such that the stirring unit is placed inside the container, while an opposite portion of the carrying axle can be driven by an external drive. The stirring unit is selected such that the fluid to be stirred can be stirred simply by the reciprocal up and down movement of the stirring unit without requiring rotation movement for stirring. The flexibility of the container wall and the merely axial orientated movement of the carrying axle allow for an integral production of the carrying axle and the container wall and any extra kind of sealing can be omitted. The container is still hermetically closed against the surrounding atmosphere. In contrast to all solutions with sealings, it is excluded according to the invention that a) foreign material penetrates in the sealing/support area or that the container content leaks and b) grit from sealings or carrying axles contaminates the sterile liquids. Another advantage of the present invention rests in the extremely advantageous costs of production for a single-use container with an integrated stirring device of highest stirring performances.

### BRIEF DESCRIPTION OF THE DRAWINGS

Preferred embodiments of the stirring device in accordance with the present invention are described hereinafter by way of the drawings. It is shown by:

FIG. 1 a container with a stirring unit in accordance with a first embodiment in a supporting container, partially represented by a sectional view;

FIG. 2 a container with a stirring unit in accordance with a preferred embodiment of the invention with two stirring device plates;

FIG. 3 a container with a stirring unit in accordance with another preferred embodiment of the invention with an internal channel;

FIG. 4 a container with a stirring unit in accordance with a fourth preferred embodiment of the invention for radial stirring;

FIGS. 5a to 5f three embodiments of stirring units with the flows generatable therewith represented in a strongly simplified form;

FIG. 5g a detail view of a longitudinal section across an individual flow through channel in accordance with an embodiment according to FIG. 5a;

FIG. 6a a stirring unit with a detail enlargement of the connection area between container wall and stirring unit whereby the latter is omitted on the left side;

FIG. 6b a further embodiment of a stirring unit in the connection area between container wall and flange of the stirring unit;

FIG. 6c a further embodiment of a stirring unit in the area of a direct fixation of the container wall to the carrying axle of the stirring unit;

FIG. 6d a further embodiment of a stirring unit in the fixation area of the container wall to the carrying axle;

FIG. 7 a further embodiment of a container with a stirring unit in the fixation area of the container wall on a tube spout of the carrying axle;

FIG. 8a a further embodiment of a container with a stirring unit with a spin filter in a longitudinal section;

FIG. 8b an enlargement longitudinal section across the spin filter according to FIG. 8a;

FIG. 8c a detail enlargement of a longitudinal section across a stirring device plate inside a spin filter according to FIGS. 8a and 8b;

FIG. 9a a further embodiment of a container with a stirring unit with a spin filter in a longitudinal section;

FIG. 9b a detail enlargement of the coupling area of the carrying axle and the driving shaft of a stirring unit according to FIG. 9a; and

FIG. 10 a further embodiment of a container with a stirring unit with a spin filter in the longitudinal section.

### DETAILED DESCRIPTION OF THE DRAWINGS

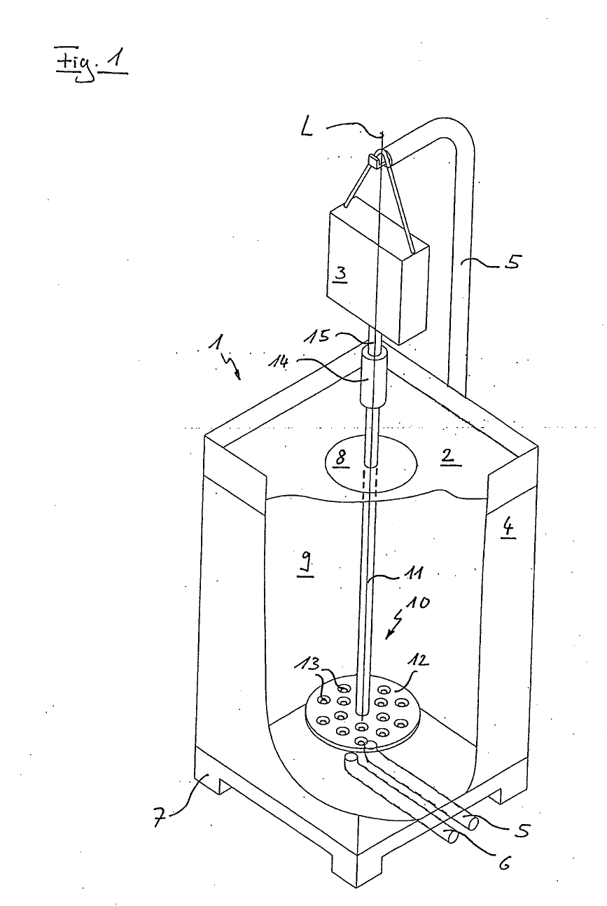

FIG. 1 outlines a flexible single-use container 1 which is received and stabilized by a supporting container 4, for example a rectangular metallic container. The container 4 comprises, in the represented embodiment, a base plate 7 provided with breakouts for inlets and/or outlets 5, 6 of the container. If single-use containers are used without base an inlet and/or outlet, the breakouts in the bottom can be omitted. The container can also comprise a double shell with a tempering device. The form is adapted to the single-use container and can be appropriately chosen for the single-use container from a circular cylinder to a polygonal form. The single-use container is preferably made of transparent foil material and can be provided on an upper side or as shown in FIG. 1 on the lower side in a known manner with connections 5, 6 for the supply and/or the evacuation of material. The single-use container 1 is provided with a stirring unit 10 in the embodiment as shown. A stirring device shaft 11, also called carrying axle is penetrating the container wall 2 in the upper region. At a lower end of the carrying axle 11 a stirring device plate 12 is formed on which is substantially perpendicular to the carrying axle 11. At the opposite upper end, the carrying axle 11 is connected via a coupling 14 to a driving shaft 15 of a drive 3 that is suspended via an arm 5 to the recipient 4. The carrying axle 11 can be brought in an up and down movement along its longitudinal axis L by means of the drive 3. The carrying axle 11 transfers this up and down movement or vibration to the stirring device plate 12 which is attached at its opposite end thereof. For many applications a unregulated drive operating at a frequency of about 50 Hz depending on the power supply frequency suffices. The stroke can be adjusted by basic mechanical means. Linear motors whose frequency and stroke can be varied within a large range have proved of value in large-scale applications.

The stirring device plate 12 is provided with a number of flow through channels 13 having conical shell surfaces 16 each. If the stirring device plate 12, as represented by FIG. 1, is moved upwards in an incompressible liquid, a liquid jet is released at the tapered end of the flow through channels 13 in the opposite direction causing the stirring device plate to move. This “Venturi” effect has been well investigated and has already been mathematically described by Bernoulli. During the operation of the stirring device, the liquid is thus pumped in the direction of the tapered end of the flow through channels. The liquid is brought into movement by the up and down movement of the stirring unit as desired, without requiring a rotation movement of the stirring unit for the stirring operation. For the embodiment, as shown, the amplitude of the vibration and the deviation of the stirring device plate 12 respectively, is in a range of about 1.5 mm.

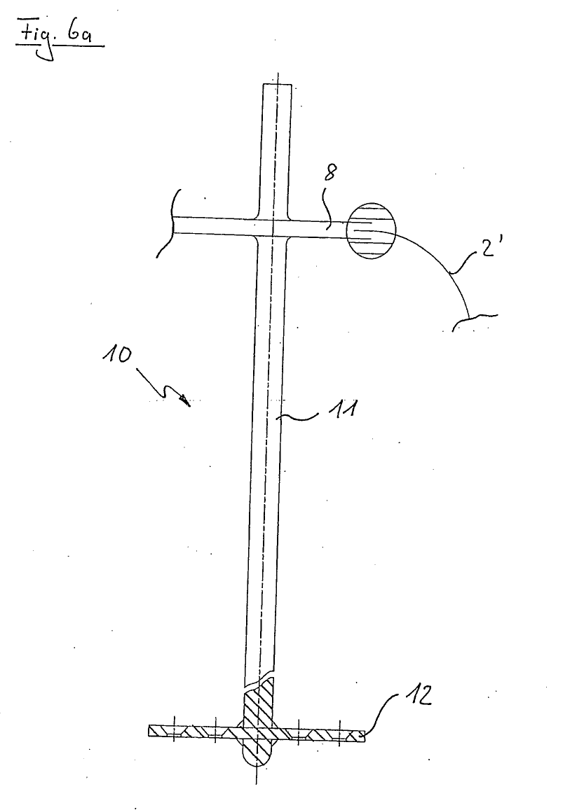

FIG. 5a shows an embodiment of a container in accordance with the present invention together with a stirring device whose flow through channels are tapering from the top to the bottom. The arrow A in dotted lines indicates the upward movement of the stirring device plate 12 and the arrow P indicates the pumping direction of the liquid. The arrows in the FIG. 5d indicate my means of arrows the type of flow which can be generated by the up and down movement of the stirring unit in accordance with FIG. 5a. Further Other pairs belonging to each other are shown in the FIGS. 5b and 5e as well as FIGS. 5c to 5f.

In FIG. 5b the flow through channels 13′ taper upwards, such that the fluid is pumped upwards in direction B at a downward movement A′ of the plate 12′. In FIG. 5e a filled container is shown again whereby the arrows indicate the flow path produced by the vibrating stirring unit. FIG. 5g outlines a single flow through channel 13 in a cross section, as shown, for example in the embodiment in accordance with FIG. 5a. The channel 13 tapers downwards; whereby the angle of slope α/2 of the shell surface 16 is 45° in the represented preferred embodiment. The through flow channel 13 located at the lower end defines a short nozzle zone 17 through which the liquid is coming out downwards during the pumping movement. In the embodiment in accordance with FIG. 5b, the inversion of the pumping direction is obtained in that the through flow channels 13′ represent the identical principal construction, but are arranged inverted in the stirring device plate.

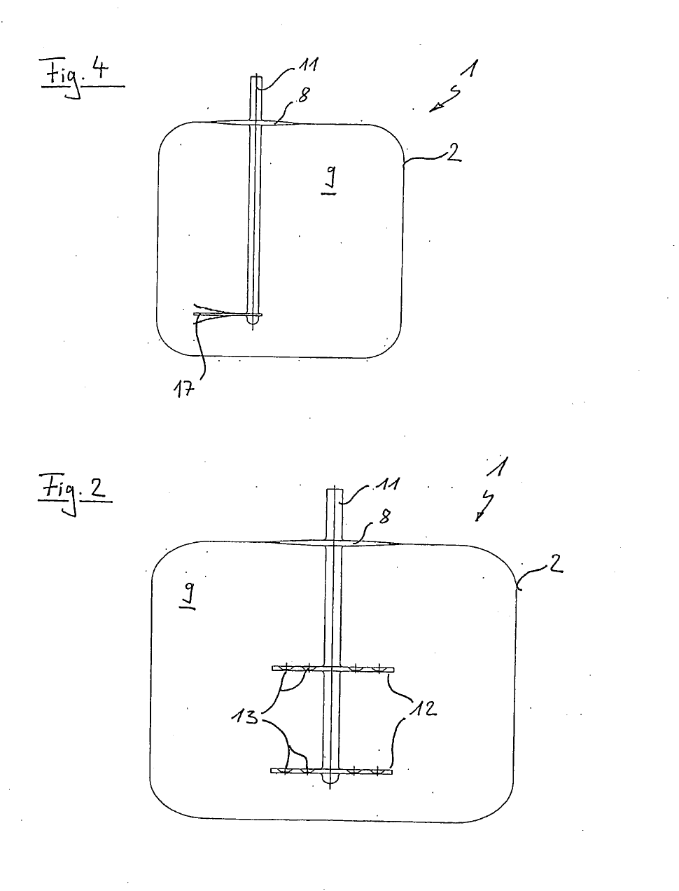

FIGS. 2 to 5 show a number of preferred embodiments for stirring units and stirring device plates. For container volumes from 0.1 to 50 liters, plate diameters of 23 mm, 45 mm, 55 mm, 65 mm or 85 mm are advantageous. For container volumes of 20 to 150 liters, plate diameters of 100 or 135 mm are advantageous, for volumes from 50 to 800 liters, plate diameters from 300 to 380 mm are advantageous. The plate's dimensions are designed according to the stirring task and viscosity. At the external diameter of the stirring plate, a conical edge or funnel from 5 to 20 mm high and a slant between 30 to 45° can also be integrated which reinforces additionally the stirring effect.

As shown on the FIG. 2, several stirring device plates can be arranged on the carrying axle. In another preferred embodiment of the present invention, not shown on the drawings, the stirring device plate is not perpendicular to the carrying axle but arranged parallel to the said carrying axle. The flexibility of the container wall allows not only an up and down movement of the carrying axle but a torsional vibration or a pendulum vibration can also be applied. The supporting unit is brought into a so called rotating vibration during the torsional vibration, i.e. a rotation movement is started in a direction but stopped after some angular degrees and the rotation movement in the opposite direction starts. Preferably, in case of a pendulum vibration, the centre of rotation is located in a contact zone between the container wall and the carrying axle which thus minimize the amplitude of pendulum vibration. All these types of vibration can also be combined and/or superposed.

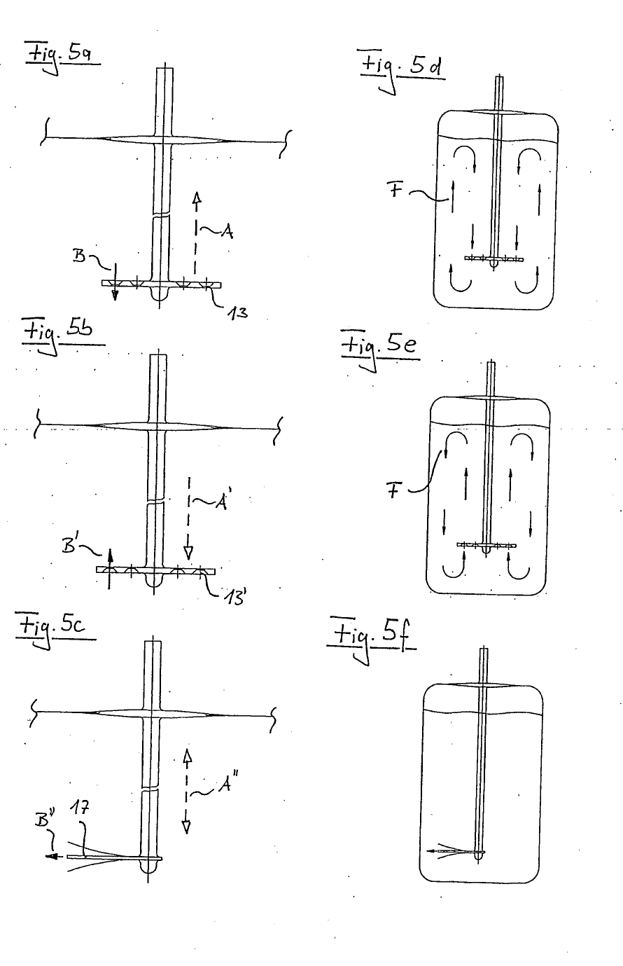

In the FIGS. 4 and 5c and 5f the supporting device plates are formed as elastically deformable plates. The said plates are brought into vibration by the vibration movement A″ of the carrying axle itself and/or brought into eigenvibration. In an embodiment with a plate 17 arranged on the left side, as shown on the FIGS. 4, 5c and f, the liquid associated to the carrying axle is mainly radially pushed away in the direction B″ by the oscillation A″. The deflection of the elastic plate 17 upwards or downwards is indicated on the FIG. 4 in dashed lines.

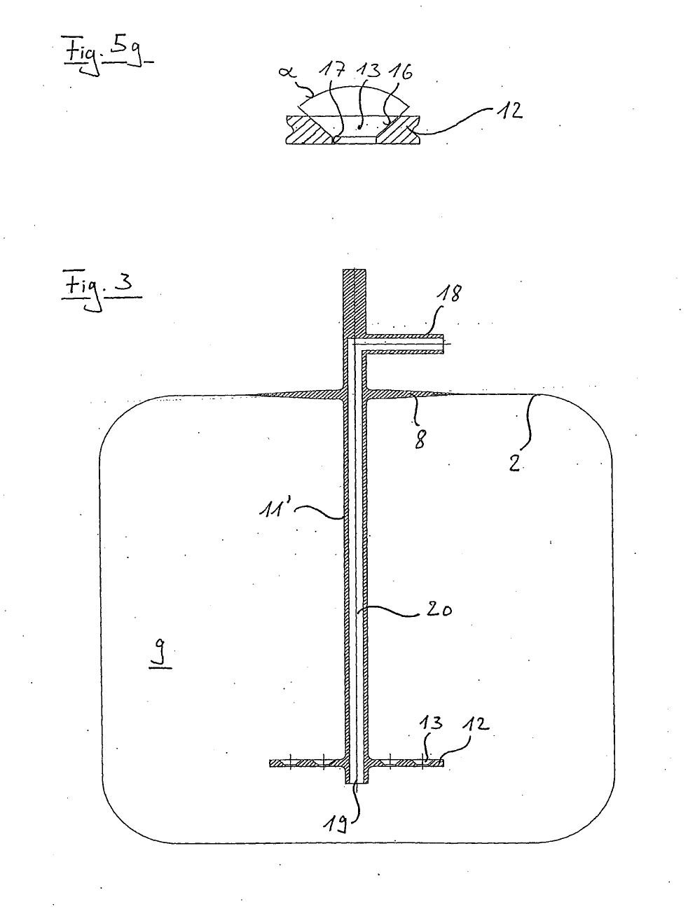

In the FIG. 3 a further preferred embodiment of a stirring unit is shown by which the carrying axle 11′ is substantially realised in form of a pipe with a central cavity 20. A connector 18 is arranged laterally in the upper region of the carrying axle outside the container, through which gas, liquids and substances flowable can be supplied to the inner space of the container or sucked therefrom. In the shown example of the embodiment, the channel end 19 is arranged at the lower end of the carrying axle 11′. Because the flexible container wall allows the lowering of the carrying hose to the bottom of the container and even its to-and-fro movement at this place, the liquid can almost be entirely sucked from the interior of the container, for example, during the evacuation of the container. A container in accordance with this embodiment doesn't need extra connections and/or inlets to the interior of the container according to the area of application in a simplest case. This is interesting not only for production or cost reasons but particularly advantageous for sterile applications as each extra inlet or connection can represent a further potential contamination source or a further potential leak.

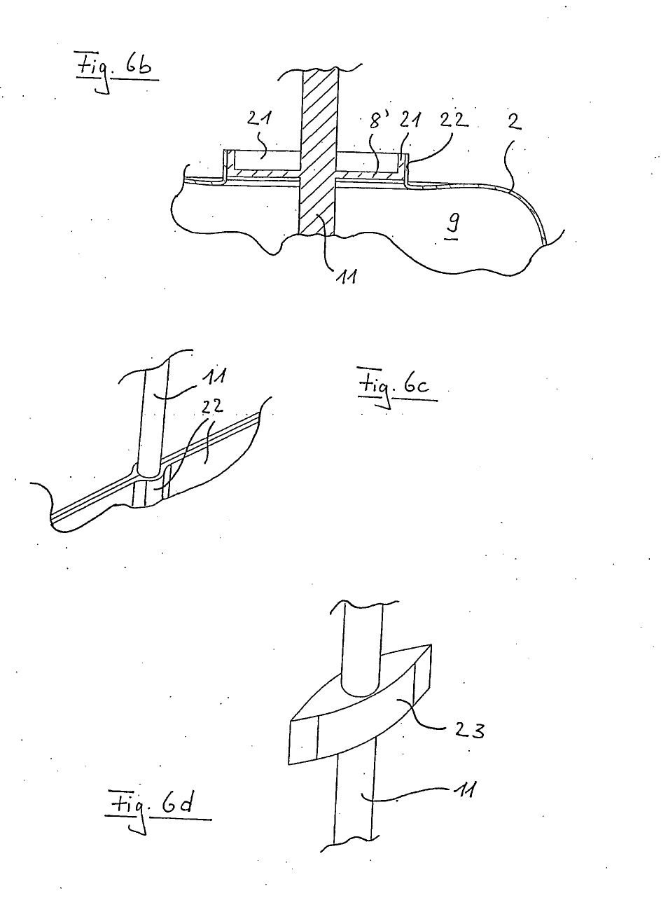

The FIG. 6 represents different ways to connect the stirring unit itself sealingly with the container wall. The FIG. 6a represents a flange 8 perpendicular to the carrying axle 11′. In the peripheral region of the flange 8, the container wall is preferably sealingly connected to the flange by welding and sticking but can also be clamped or flanged with appropriate means with this container wall. The detail enlargement indicates that the container wall 2″ is made of five layers whereby the two external layers (for example, a PET- and PA layer) are attached on the upper surface of the flange and the median layer (for example, a “Tie-layer”) is welded or glued into the flange; the internal layers (for example, a EVOH- and a ULPDE-layer) being attached on the bottom side of the flange. In case of an integrally prefabricated container, it is advantageous to provide the flange with a peripheral outward protruding rib 21 to which a collar 22 of the container wall 2 can be reliably attached, because the connection region is easily accessible on both sides. The stirring unit is preferably made of PE, PP, PEEK or PVDF. The stirring units for small volume applications are preferably integrally casted while larger stirring units can be made of several parts. The carrying axle can, for example, be strang extruded and the preferably fabricated stirring device plates, flanges, connectors and/or inserts, preferably made by die-casting, are arranged in a second step on the carrying axle.

The FIGS. 6c and 6d show further embodiments by which the container wall is directly welded/glued with the carrying axle in the aperture region. In the embodiment in accordance with the FIG. 6d a double-shaft insert 23 is realised on the carrying axle which simplifies the fixing of the container wall on the carrying axle. In both cases one cut or a prefabricated aperture of an adequate size in the upper container wall are sufficient for the insertion of the stirring unit. After the insertion of the stirring unit the container wall is fixed on the carrying axle and simultaneously or subsequently the still available cutting edges of the container wall are connected together in order to close the cut. The connections are preferably performed by welding.

If gas should flow through the cavity 20, then a number of corresponding apertures is preferably arranged in the hose 11′ and the gas is supplied to the liquid through the said apertures. The communicating connection existing through the channel 20 between the connectors 18 and the channel end 19, respectively the container inner space 9 can be sealingly closed off by appropriate means in the channel or the terminations thereof.

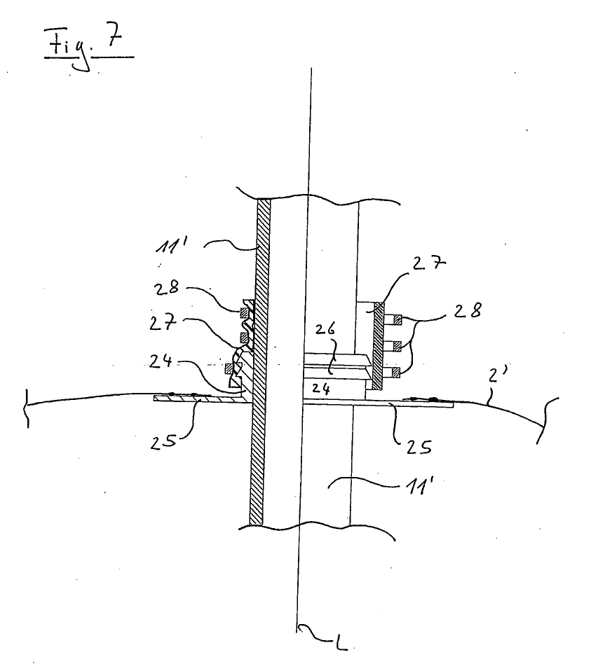

The FIG. 7 shows that in a further preferred embodiment of the invention the container wall 2′ can be attached by means of a hose spout 24 made of an appropriate plastic material and the said hose spout can be fitted again on the carrying axle 11′. The container wall 2′ is sealingly welded to a radially protruding flange 25 of the hose spout 24.

The FIG. 7 drafts how the fitted hose spout 24 can be attached on the carrying axle 11′ by means of a hose piece 27 and hose clamps 28. The hose piece, for example, a piece of silicone hose or an EPDM-hose can be slided, as indicated on the right drawing half, on the hose spout 24 and sealingly attached by means of hose clamps 28 to the spout 24 as well as to the carrying pipe 11′, as shown on the left drawing half. In order to improve the hold of the hose piece 27 on the spout 24 and to simplify the sliding, circumferential ribs 26 with a conical cross-section are provided, as it is known from hose connectors and hose spouts from the state of the art. The connection between the hose spout and the carrying axle can be performed either permanently or also movably in determined embodiments so as to release the connection according to the requirements, for example, for the disposal of the single-use container and so as simply remove the stirring unit.

Generally, it is essential that the inlets and/or outlets of the single-use container can be equipped according to the requirements and area of application with standard connections, couplings, filters and/or valves. The connections and the container walls are preferably welded or glued. The connections are mostly conducted through all layers of the container wall and preferably clamped, respectively attached by means of underside-and-topside connections. Then, the underside-and-topside connections are welded with the layers of the container wall.

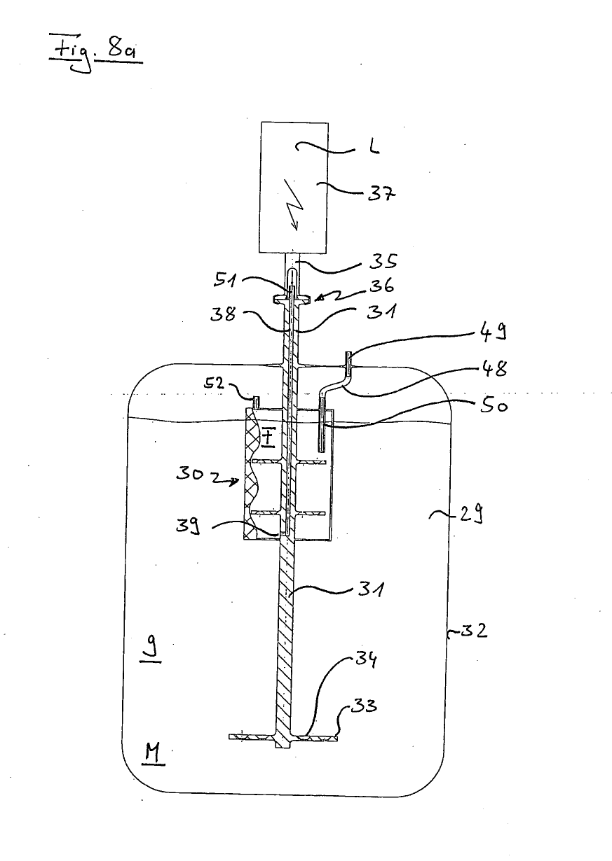

The FIGS. 8 to 10 show other preferred embodiments of the container according to the present invention in which container a spin filter 30, 30′ is arranged on the carrying axles 31, 32, 33, respectively. The spin filter showed their efficiency in the cell culture technology for the perfusion as they reliably retain the cells. The use of spin filters with Bioreactors is well known by the applicant which can be driven contactless by means of stirring units via magnetic couplings. In order to ensure the function of the spin filters, the clogging of the membranes in the spin filter must be prevented to allow a culture of the cells over a long period. Membranes are known which comprise multi-layer, woven stainless steel screens with mesh sizes or pore sizes below the average cell size. A disposable spin filter with a base body made of polycarbonate is known from the Company Sartorius BBI Systems GmbH on which an open-meshed precision tissue is applied whereby the filter tissues are made of monofilaments and comprise controlled, reproducible mesh sizes with small tolerances.

Because the clogging, also called “screen fouling”, further addresses a problem, it has been proposed to increase the mesh size whereby the lixiviation of the cells can become problematic.

According to the present invention, it has been proposed to arrange a spin filter in the upper region of the carrying axle so that the said spin filter immerges, at least partially, preferably in the medium contained in the filled container. More preferably, the spin filter immerges almost entirely in the medium and surrounds one or several stirring device plates arranged on the carrying axle.

The FIG. 8a shows a first embodiment of a container 29 with a carrying axle 31 which carries at a lower end a first container device plate 33 with flow through openings 34 and a spin filter 30 above the said plates. The stirring device plate 33 corresponds to the stirring device plates previously described. The substantially cylindrical spin filter 30 is enlarged in the FIG. 8b. A bottom plate in form of a circular disk and an approximately congruent cover plate 42 are attached or moulded spaced apart to the carrying axle 31 and limit in co-operation with a membrane 40 a spin filter's inner space 43 with respect to the container's inner space 9. The closed realisation of the spin filter according to the invention is particularly advantageous as the foam building in the medium M is minimised.

In the represented example of embodiment, an upper stirring plate 45 and a lower stirring plate 44 are arranged coaxially and spaced apart on the supporting shaft 31. The axial position of the stirring plates 44, 45 on the carrying axle 31 has been selected so that the said stirring device plates are located entirely in the filled container, taking also in consideration the stroke movement of the stirring unit in the filled medium M.

The FIG. 8c shows one of the stirring plates 44, 45 in a detail representation which clearly shows that the said stirring device plate carries the reversely acting flow through channels 46, 47. While the channels 46 are tapering downwards by an upward movement of the plates 44, 45 an applied liquid is pumped downwards when the channels are tapering downwards so that by a downward movement of the plates 44, 45 the applied liquid is pumped upwards. The geometry of the different flow through channels 46, 47 correspond advantageously to the geometry already previously described. The FIG. 8c exhibits that the slope angle of the shell surface of the channels is of 45° again in the preferred represented embodiment and that on the lower, respectively, the upper end, the flow through channels define respectively a short nozzle region in form of a circular cylinder through which the applied liquid exits during the upwards pumping movement, respectively, downwards. On the contrary to the embodiment described on the FIG. 5, the pumping is here performed in two directions by each up-and-down movement of the carrying axle and an optimum stirring is obtained in the small volume of the spin filter 30.

The FIG. 8a clearly shows that the inner space 43 of the spin filter 30 is in a communication connection with the external side of the single-use container 29 via two conduits 38, 48. The first conduit 38 is integrated in the carrying axle and extends from one external connector 51 at the upper end of the carrying axle 31 to a radial channel 39 which radially penetrates the carrying axle 31 and ends almost above the bottom plate 41 of the spin filter 30 in the inner space 43. A second inlet conducting to the inner space 43 of the spin filter 30 is performed by a conduit in the form of a flexible hose connection 48 between a connector 49 in the upper container wall 32 and a connector 50 in the cover plate 42 of the spin filter 30. The connector 50 is preferably so far lowered in the inner space of the spin filter 30 that the aperture on the lower side ends in the medium, in the inner space of the spin filter, hereinafter called liquid F. The inner space of the spin filter 30 can be supplied with gas and/or liquid or media flowable, as desired, via connections 49 and 51 or some liquid can be sucked form the spin filter. If needed, further connection conduits can be produced between the spin filter and the external side of the container, as indicated by connector 52. This connector 52 is sealingly closed by the examples described in detail.

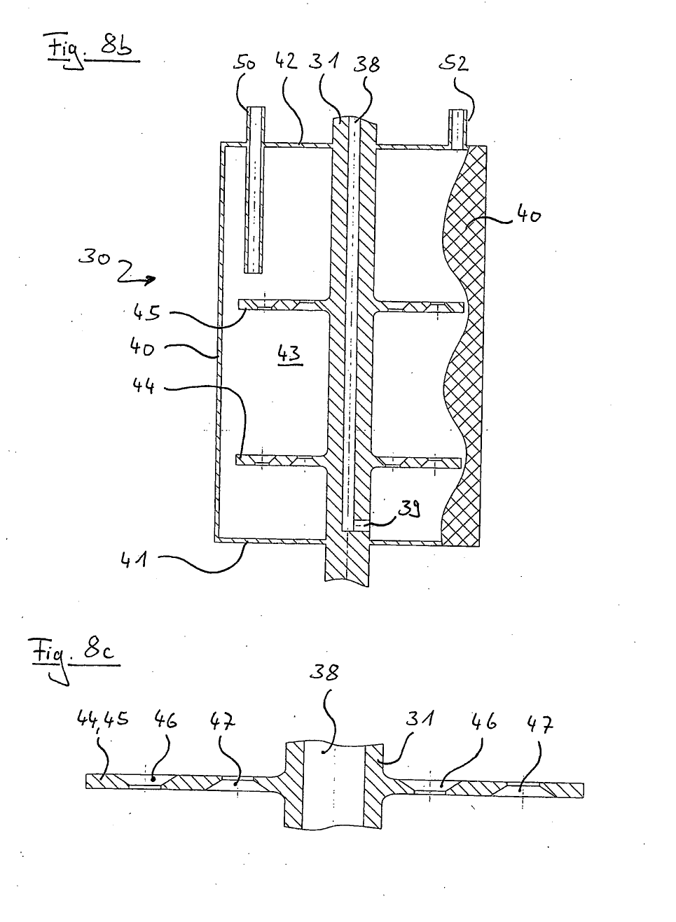

The FIG. 9a shows that according to a further advantageous embodiment, two inlets can be realised in the inner space of a spin filter 30′ also by means of two conduits 61, 62 integrated in a carrying axle 60. The carrying axle shows at its upper end, respectively two connectors 63, 64 in the coupling region of the carrying axle, on the drive 37. The FIG. 9b clearly shows that the two connectors 63, 64 are accessible on both sides via an U-recess in the driving shaft 35.

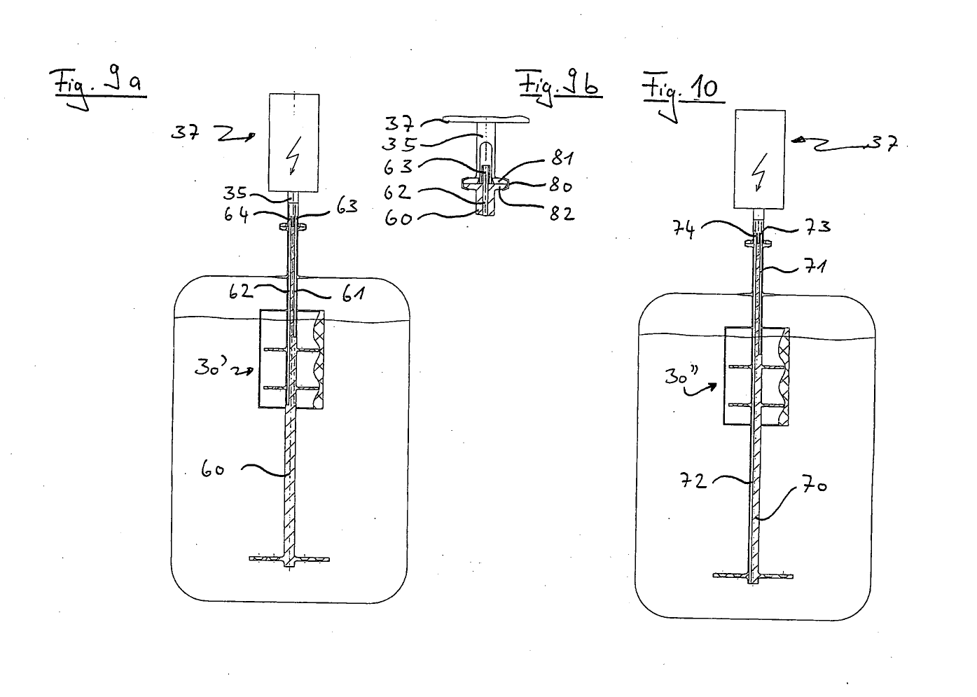

A more preferred embodiment is represented on the FIG. 10. In the view, according to the FIG. 10, two conduits 71, 72 are again integrated in a carrying axle 70. The first shorter conduit 71 ends in the inner space of the spin filter 30″ while the parallel conduit 72 ends at the lower end of the carrying axle 70 in the corresponding inner space of the container and creates a communicating connection between the said inner space and the connector 73 located on the upper side. From the two inlets going through the carrying axle, a first one 71 conducts to the inner space of a spin filter 30″ and a second one 72 conducts directly to the lower end of the carrying axle and thus to the bottom of the container's inner space. The supporting shaft shows at its upper end, again two connectors 73, 74 in the coupling area of the supporting shaft on the drive 37.

The previously described FIGS. 8, 9 and 10 depict an advantageous embodiment for the fixing of the supporting shaft on the driving shaft 35. FIG. 9b shows that the upper end of the supporting shaft 60 and the corresponding lower end of the driving shaft 35 are provided each time with approximately congruent flanges 81, 82 which are movably attached together by a fitted security clamp 80.

### LIST OF THE REFERENCE NUMBERS

1 single-use container
2 container wall
3 drive
4 recipient
5 inlet
6 outlet
7 base plate
8 flange
9 container inner space
10 vibration stirring unit
11, 11′ supporting shaft
12 stirring device plate
13 through flow channel
14 coupling
15 driving shaft
16 shell surface
17 swinging plate
18 connectors
19 channel end
20 cavity
21 rib
22 collar
23 insert
24 tube spout
25 flange
26 ribs
27 tube piece
28 tube flanges
29 container
30, 30′, 30″ spin filter
31 supporting shaft
32 container wall
33 stirring device plate
34 flow through channels
35 driving shaft
36 coupling
37 drive
38 conduit
39 aperture
40 membrane
41 base plate
42 cover plate
43 spin filter inner space
44 stirring device plate
45 stirring device plate
46 flow through channels
47 flow through channels
48 conduit
49 connector
50 connector
51 connector
52 connector
60 supporting shaft
61 conduit
62 conduit
63 connector
64 connector
70 supporting shaft
71 conduit
72 conduit
73 connector
74 connector
80 security clamp
81 flange
82 flange
F liquid
L longitudinal axis
M medium

1. A container (1), fabricated out of plastic material, for stirring or mixing sterile liquids for the chemical, biotechnological, pharmaceutical and food industry comprising:
a stirring unit (10) having a flexible container wall (2) is penetrated by a supporting shaft (11, 11′) integrally connected with the container wall; and
an area of the supporting shaft (11) arranged in an inner space (9) of the container (1) and supporting at least one stirring device plate (12, 12′, 17) and an area, which is located outside the container, connected with a drive (3).

2. A container (1) according to claim 1, wherein the container (1) and the integrally connected stirring unit (10) are sterile single-use articles to be recycled after single use.

3. A container (1) according to claim 1, wherein the container wall (2) is welded, glued, clamped or flanged in the penetration area with the supporting shaft (11).

4. A container (1) according to claim 1 wherein the supporting shaft is fabricated out of plastic material selected from the group consisting of PE, PP, PEEK or PVDF.

5. A container (1) according to claim 1 wherein the container wall (12) penetrated by the supporting shaft presents a multi-layer construction; whereby the said container wall is selected from the group consisting of PET-layer, a PA-layer, a EVOH-layer or a ULPDE-layer.

6. A container (1) according to claim 1 wherein the supporting shaft (11) and a stirring unit (12) arranged thereon can be moved up-and-down by a drive (3) in an axial direction with a frequency in the range of minimum 10 Hz to maximum 500 Hz, preferably, 50 Hz.

7. A container (1) according to claim 1 wherein the supporting shaft (11) and therefore at least one stirring unit (12) arranged thereon can be brought into movement by the drive (3) in a rotation vibration with a frequency in a range of minimum 10 Hz to maximal 500 Hz.

8. A container (1) according to claim 1 wherein the supporting shaft (11) and therefore at least a stirring unit (12) arranged thereon can be brought in movement by the drive (3) in a pendulum oscillation with a frequency in the range of minimum 10 Hz to maximum 500 Hz; whereby the rotation point is located in the penetrating zone of the container wall and the supporting shaft.

9. A container (1) according to claim 1 wherein the alternating flow generated by the stirring unit (12) is rectified in a directed jet flow by means of inclined surfaces arranged on the stirring unit (12).

10. A container (1) according to claim 9 wherein the stirring unit is a stirring plate (12) which comprises conical through flow channels (13) and in that the inclined surfaces are formed by the internal walls of the through flow channels.

11. A container (1) according to claim 10, wherein the directed jet flow is substantially perpendicular to the plane of the stirring unit.

12. A container (1) according to claim 1 further comprising:
a spin filter (30, 30′, 30″) arranged on the supporting shaft (31, 60, 70) with at least one communicating connection between an inner space of the spin filter (43) and an external side of the container.

13. A container (1) according to claim 12, wherein the spin filter (30, 30′, 30″) is arranged on the supporting shaft (31, 60, 70) so that the said filter is emerged in case of a filled container preferably, at least partially, in the container medium.

14. A container (1) according to claim 12 further comprising:
at least one stirring device plate (44, 45) is arranged in the inner space of the spin filter (43).

15. A container (1) according to claim 12, further comprising:
at least one conduit (38, 61, 61, 71) in the supporting shaft (31, 60, 70) or a tube connection (48) forming the communicating connections between an inner space of the spin filter (43) and an external side of the container.

16. A container (1) according to claim 12, further comprising:
a base plate (41) in form of a circular disc and an almost congruent cover plate (42) fixed or moulded spaced apart on the supporting shaft (31) and limiting, in co-operation with the membrane (40), the spin filter inner space (43) with respect to the container inner space (9).

17. A container (1) according to claim 1 wherein the container wall (2) is welded, glued, clamped or flanged with a flange (25) of a tube spout (24) arranged on the supporting shaft (11′) and tightly connected thereon.
